(19) United States
(12) Patent Application Publication
(10) Pub. No.: US 2024/0337330 A1
(43) Pub. Date: Oct. 10, 2024

(54) POSITION SENSOR FOR A VALVE AND METHOD FOR MEASURING THE POSITION OF A VALVE

(71) Applicant: VOLKSWAGEN AKTIENGESELLSCHAFT, Wolfsburg (DE)

(72) Inventor: Tom KRUSE, Bad Gandersheim (DE)

(21) Appl. No.: 18/627,232

(22) Filed: Apr. 4, 2024

(30) Foreign Application Priority Data
Apr. 6, 2023 (DE) 10 2023 203 231.7

(51) Int. Cl. F16K 37/00; F25B 41/20

(52) U.S. Cl. CPC F16K 37/0041; F25B 41/20

(57) ABSTRACT

A position sensor for a valve and a method for measuring the position of a valve. To determine the position of a valve, a valve body is moved at least partially within a coil or conductor loop, or a valve body connected to a coil or conductor loop is moved within the valve; the electrical properties of the coil or conductor loop are measured; and the position of the valve body within the valve is determined from the measured electrical properties.

### PRIORITY CLAIM

This patent application claims priority to German Patent Application No. 10 2023 203 231.7, filed 6 Apr. 2023, the disclosure of which is incorporated herein by reference in its entirety.

### SUMMARY

Illustrative embodiments relate to a position sensor for a valve and to a method for measuring the position of a valve.

### BRIEF DESCRIPTION OF THE DRAWINGS

Exemplary embodiments will be explained with reference to drawings, in which:

FIG. 1 is a schematic illustration of an exemplary valve with position identification;

FIG. 2 is a flowchart of an exemplary method for identifying the position of a valve; and

FIGS. 3a and 3b are schematic illustrations of the physical principles of the disclosed position identification.

### DETAILED DESCRIPTION

The described valve consists, in particular, of a movable valve body with a valve shaft and a sealing body which moves in a valve housing. For this purpose, the valve body may be set in rotation using a motor and this rotation is converted into a linear movement, which opens or closes the valve, using a thread.

An arrangement of this kind is known, for example, from CN112555427 A. In this document, the valve is equipped with a position sensor between the upper end of the valve shaft and the upper end of the valve body, this position sensor being able to accurately measure the linear displacement of the valve shaft. A controller sends a pulse signal to a coil to control the rotation of the rotor components, and then converts the rotational movement of the rotor into a linear displacement of the valve rod by a threaded transmission pair. The linear displacement of the transmission rod has the effect that a metal wire deforms and the corresponding resistance value for the metal wire changes. In the signal transmitter, the change in the resistance value of the metal wire is converted into the position opening of the valve rod and fed back to the controller, wherein the position opening is adjusted in the closed control loop by the adjusted opening, this improving the control accuracy.

US 2022/0154851 A1 discloses an electronic expansion valve for a cooling system. The electrical expansion valve comprises: a valve seat which is provided with an inlet, an outlet and a connecting channel which is connected to the inlet and the outlet; an actuator which is fitted movably in the valve seat, wherein the actuator is provided with a first position to block the connecting channel and a second position to bypass the connecting channel, and a drive mechanism which is connected to the actuator to move the actuator between the first position and the second position.

For example, DE 4341102 A1 discloses providing the valve rod with a magnet and determining the position of the magnet using a Hall element.

Disclosed embodiments allow the position of a valve to be determined in a precise and cost-effective manner. In particular, this position determination should be performed in a contact free manner.

This is achieved by a position sensor for a valve, a valve, a refrigeration machine having a valve, and a method.

In particular, the disclosed embodiments are based on the following idea: an inductor, that is to say a coil or conductor loop, is constructed so as to engage around the spindle of a valve body. The actuator of the valve moves within the coil or conductor loop and thus changes its electrical properties. In particular, the insertion of a ferromagnetic material into an inductor or the air gap in the inductor changes the value of this inductance.

The changing inductance may be detected by an electronics system in the valve and the position of the actuator is ascertained from this. The inductance of the stator can be used in the motor moving the valve, or the coil or conductor loop to be measured can be integrated into the stator of the motor.

In particular, this is achieved by providing a position sensor, comprising a movable valve body and a stationary coil or conductor loop which at least partially surrounds the valve body. Also provided is a way for measuring the electrical properties, in particular, the inductance, of the coil or conductor loop, wherein the electrical properties of the coil or conductor loop are changed by moving the valve body within the coil or conductor loop.

As an alternative, the inductor of which the properties are measured can be embodied by a coil or conductor loop on or in the valve body. In this case, the electrical properties of the coil or conductor loop can be measured, for example, by sliding contacts.

The measured electrical properties of the coil or conductor loop may be an inductance value and/or an impedance, that is to say a complex resistance of the coil or conductor loop. These properties can be measured by applying an AC voltage or an alternating current to the coil or conductor loop and measuring a frequency-dependent resistance, measuring a phase between current through and voltage across the coil or conductor loop, measuring a resonant frequency of an oscillating circuit comprising the coil and a capacitor, or by measuring the time profile of a voltage across the coil or conductor loop after application of a current or the time profile of the current through the coil or conductor loop when a voltage is applied.

The valve body may be moved using a motor, the motor may be configured to set the valve body in rotation about an axis, and the valve further comprises a threaded connection which is configured to convert the rotation of the valve body into a linear movement along this axis.

Here, the valve body consists of a spindle-like valve shaft and a conical sealing body.

The valve body of the valve may be connected to the rotor of the motor or at least constitutes part of this rotor.

The coil or conductor loop of which the electrical properties are measured may be connected to the stator of the motor or constitutes at least part of this stator.

The valve may be suitable for acting as an expansion valve, multiway valve or shut-off valve in a refrigerant circuit, particularly in a refrigerant circuit of a transportation vehicle.

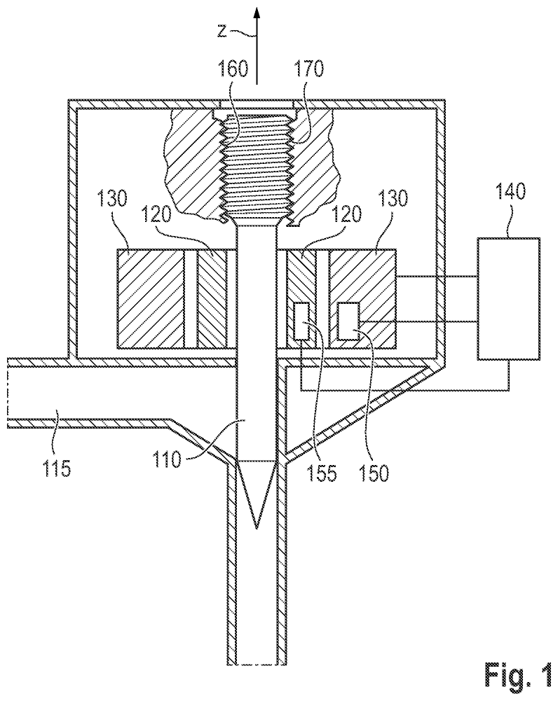

FIG. 1 shows a valve 100 which describes various embodiments. This valve consists of a movable valve body 110 which is movable along a direction z to block off a line 115. For this purpose, the valve body 110 is set in rotation about the z-axis using a motor consisting of a rotor 120 and a stator 130, it being possible for the rotation to be converted into a linear movement along the z-axis using a threaded connection 160, 170 consisting of a thread 160, which is connected to the valve body, and a stationary thread 170.

The figure also shows a position sensor consisting of a coil or conductor loop 150, 155 which is embodied either as a coil or conductor loop 150 which at least partially surrounds the valve body 110 or as a coil or conductor loop 155 which is connected to the valve body 110. In particular, this coil or conductor loop can constitute the stator 130 or the rotor 120 of the motor or can be integrated into the stator or rotor. The electromagnetic environment and thus the electrical properties, in particular, the inductance, of the coil or conductor loop are changed owing to the movement of the valve shaft 110 within the coil or conductor loop 150 or the coil or conductor loop 155 within the valve, in particular, within the stator 130.

The figure further shows a mechanism 140, for example, a measurement electronics system, to read out the electrical properties, in particular, the inductance, of the coil or conductor loop 150, 155 that have been changed by the movement of the valve body 110. Using the changes in these properties, the measurement electronics system or other corresponding mechanism 140 can then determine the position of the valve body 110 in the valve 100.

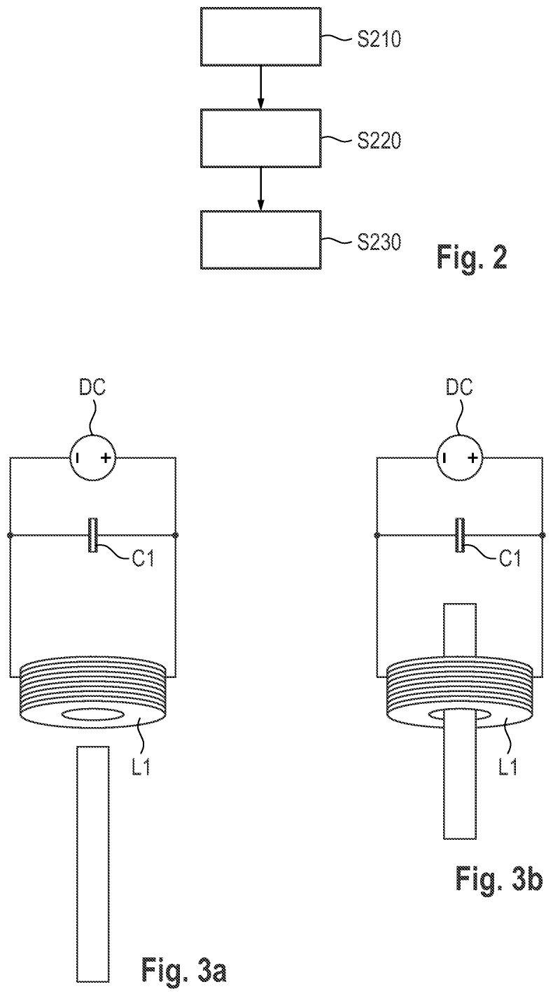

FIG. 2 shows a flowchart of a disclosed method: in a first operation at S210, a valve body 110 is moved at least partially within a coil or conductor loop 150 or connected to a coil or conductor loop 155. In the following, second operation at S220, the electrical properties, in particular, the inductance, of this coil or conductor loop 150, 155 are then measured and finally, in a further, third operation at S230, a position of the valve body 110 is determined from the thus measured electrical properties.

FIGS. 3a and 3b show a schematic illustration of the physical principles of the disclosed position measurement.

FIG. 3a shows an LC resonant circuit consisting of a coil L1 (e.g., the rotor 120 or the measuring inductor 150, 155) and a capacitor C1. The resonant frequency of this resonant circuit is given by

$$f = 1 / ( 2 π \sqrt{LC )} , \qquad ( 1 )$$

where C is the capacitance of the capacitor C1 and L is the inductance of the coil L1. In this example, the inductance L is calculated by

$$L = {μ}_{0} {μ}_{r} {N}^{2} A / l . \qquad ( 2 )$$

Here, N is the number of turns, A is the cross-sectional area, l is the length of the coil L1; μ0 is the vacuum permeability 4π·10-7 N/A2 and μR is the relative permeability of the incorporated volume. For non-ferromagnetic materials or air, μR is in the order of magnitude of one.

FIG. 3b shows how a ferromagnetic material, e.g., the rotor 120 of the valve body, has been inserted into the coil L1. This increases the value of μR by a factor of between a few hundred and 10 000 and thus reduces the resonant frequency of the resonant circuit according to formula (1) by a factor of 10 to 100. This pronounced change in the resonant frequency allows precise determination of the position of the ferromagnetic materials within the coil.

### LIST OF REFERENCE SIGNS

100 Valve
110 Valve body
115 Line
120 Rotor
130 Stator
140 Mechanism for measurement
150, 155 Coil or conductor loop
160 Thread on the valve body
170 Stationary thread
z Movement axis
200 Flowchart
S210 First operation (moving the valve body)
S220 Second operation (determining the inductance)
S230 Third operation (determining the position of the valve body)
L1 Coil
C1 Capacitor
DC Voltage source

1. A position sensor for a valve, the position sensor comprising:
a movable valve body;
a coil or conductor loop which at least partially surrounds the valve body or is connected to said valve body; and
a mechanism for measuring the electrical properties of the coil or conductor loop,
wherein the electrical properties of the coil or conductor loop are changed by moving the valve body within the coil or conductor loop or by moving the coil or conductor loop within the valve such that a position of the valve body within the valve is determinable based on the measured electrical properties.

2. A valve comprising the position sensor of claim 1.

3. The valve of claim 2, wherein the valve body is moved using a motor and is connected to the rotor of the motor.

4. The valve of claim 3, wherein the coil or conductor loop at least partially surrounds the valve body and is connected to the stator of the motor or constitutes the stator.

5. The valve of claim 2, further comprising a thread connected to the valve body that interacts with a stationary thread to move the valve body, by rotation about its axis, along the direction of this axis.

6. The valve of claim 2, wherein the valve is configured as an expansion valve, multiway valve, and/or shut-off valve in a refrigerating circuit.

7. A refrigeration machine, comprising the expansion valve, multiway valve and/or shut-off valve of claim 6.

8. A method for measuring the position of a valve, the method comprising:
moving a valve body at least partially within a coil or conductor loop or moving a valve body which is connected to a coil or conductor loop;
measuring the electrical properties of the coil or conductor loop; and
determining the position of the valve body within the valve based on the measured electrical properties.

9. The method of claim 8, further comprising moving the valve body using a motor, wherein the valve body is connected to a rotor of the motor at least partially within the coil or conductor loop, and/or wherein the coil or conductor loop constitutes the stator of the motor or is integrated into the stator.

10. The method of claim 8, wherein measuring the electrical properties of the coil or conductor loop comprises measuring an inductance value, an impedance, or a frequency-dependent resistance.

11. The method of claim 8, further comprising moving the valve body using a motor and is connected to the rotor of the motor.

12. The method of claim 11, wherein the coil or conductor loop at least partially surrounds the valve body and is connected to the stator of the motor or constitutes the stator.

13. The method of claim 8, wherein a thread connected to the valve body interacts with a stationary thread to move the valve body, by rotation about its axis, along the direction of this axis.

14. The method of claim 8, wherein the valve is configured as an expansion valve, multiway valve, and/or shut-off valve in a refrigerating circuit.
